(19) United States
(12) Patent Application Publication
(10) Pub. No.: US 2010/0102229 A1
(43) Pub. Date: Apr. 29, 2010

(54) COMBINED SENSOR FOR PORTABLE COMMUNICATION DEVICES

(75) Inventors: Gunnar KLINGHULT, Lund (SE); Donato PASQUARIELLO, Vasteras (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/259,375

(22) Filed: Oct. 28, 2008

(51) Int. Cl. G01J 5/00

(52) U.S. Cl. 250/338.1

(57) ABSTRACT

The invention relates to a sensor adapted for a portable communication device, consisting of a first layer of a light absorbing material configured to absorb photons of a first wavelength range and being transparent to photons of a second wavelength range, a second layer of a light absorbing material configured to absorb photons of a second wavelength range and being transparent to photons of said first wavelength range. The sensor is characterized by that the first and the second light absorbing material are arranged on a substrate housing electronic components of the portable communication device, whereby the first and the second light absorbing material are arranged on top of each other, and wherein at least one of the light absorbing materials is adapted to detect the level of ambient light.

### TECHNICAL FIELD

The present invention relates to the field of portable electronic devices and, in particularly, to compact and area conservative multifunctional sensors for implementation in such devices. The present invention targets especially the area of portable mobile communication devices, such as mobile phones, where area conservative sensors are highly sought for.

### BACKGROUND

The trend amongst the manufacturers of modern-day portable electronic devices is to put more and more hardware features into the device and at the same time reduce the physical size of the device. To be able to cope with these conflicting aspects, the development of area conservative hardware features are getting more important.

A typical hardware feature that has become increasingly popular to incorporate in today's portable electronic devices, such as the mobile phone, are different kind of sensors. However, these sensors often consume lot of precious area, both internally on the printed circuit board and externally on the casing, in the device. Also, in many cases these sensors need to be located in roughly the same part of the device as other electronic components such as the display, buttons, speaker, camera, etc., thus making it very hard, both for the hardware designer and the casing designers, to design the mobile phone. Therefore, finding a way to reduce the amount of area occupied by these sensors would be most welcome.

### SUMMARY OF THE INVENTION

With the above description in mind, then, an aspect of the present invention is to provide an area conservative sensor which seeks to mitigate, alleviate, or eliminate one or more of the above-identified deficiencies in the art and disadvantages singly or in any combination.

As will be described in more detail by the aspects of the present invention below, one way to provide such an area conservative sensor is to combine the function of several sensors into one sensor, thus reducing the overall amount of sensors in the device. This may for instance be done by stacking several sensors on top of each other, thus reducing the area consumed on the printed circuit board and on the casing. The stacking is done in such way that the sensors do not affect the performance of each other in any critical way.

A first aspect of the present invention relates to a sensor adapted for a portable communication device, comprising a first layer of a light absorbing material configured to absorb photons of a first wavelength range and being transparent to photons of a second wavelength range, a second layer of a light absorbing material configured to absorb photons of a second wavelength range, wherein the first and the second light absorbing material are arranged on a substrate housing electronic components of the portable communication device, whereby the first and the second light absorbing material are arranged on top of each other, and wherein at least one of the light absorbing materials is adapted to detect the level of ambient light.

The sensor may further comprise a third layer of a light absorbing material configured to absorb photons of a third wavelength range and being transparent to photons of said first and second wavelength ranges.

The sensor mat be configured in such way that the second layer of a light absorbing material is configured to be transparent to photons of said first wavelength range.

The sensor may further comprise a third layer configured to be transparent to photons of said first and second wavelength ranges.

The sensor may further comprise a fourth layer configured to reflect photons of said first or second wavelength ranges.

One of the sensors light absorbing materials may be adapted to detect the level of infrared light.

One of the sensors light absorbing materials may be made of silicon, tuned to absorb photons in the wavelength range 200 nm to 1000 nm.

One of the sensors light absorbing materials may be made of indium, gallium, and arsenide, tuned to absorb photons in the wavelength range 1000 nm to 1800 nm.

One of the sensors light absorbing materials may be made of phosphor, gallium, and arsenide tuned to absorb photons in the wavelength range 400 nm to 800 nm.

One of the sensors light absorbing materials may be made of gallium and arsenide tuned to absorb photons in the wavelength range 600 nm to 1000 nm.

The sensor may further be connected to a processing unit adapted to evaluate one or more output signals from the light absorbing materials.

The processing unit connected to the sensor may be adapted to evaluate the output signals from the light absorbing materials separately for each absorbing material.

The processing unit connected to the sensor may be adapted to evaluate a combination of output signals from the light absorbing materials.

The transparent layer in the sensor may be comprised of any, or a combination, of the following materials; glass, plastic, gas, crystal, or liquid.

A second aspect of the present invention relates to a portable communication device comprising the sensor according to the first aspect of the present invention.

The portable communication may further comprise means for evaluating one or more output signals from the light absorbing materials.

The portable communication may further comprise means for evaluating the output signals from the light absorbing materials separately for each absorbing material.

The portable communication may further comprise means for evaluating a combination of output signals from the light absorbing materials.

Any of the features described in conjunction with the first and second aspect of the present invention above may be combined in any way possible with respective first and second aspect of the present invention.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a portable communication device, in this case a mobile phone; and

FIG. 2 shows two sensors comprising two light absorbing materials, one for ambient light and one for infrared light, placed side by side on a substrate attached to a printed circuit board; and

FIG. 3a shows a sensor comprising two light absorbing materials, one for ambient light and one for infrared light, stacked on top of each other on a substrate attached to a printed circuit board, according to an embodiment of the present invention; and

FIG. 3b shows a sensor comprising two light absorbing materials, one for ambient light and one for infrared light, stacked on top of each other and connected to a processing unit, wherein the sensor and the processing unit is placed on a substrate attached to a printed circuit board, according to an embodiment of the present invention; and

FIG. 4a shows a sensor comprising two light absorbing materials, one for ambient light and one for infrared light, and a transparent material stacked on top of each other on a substrate attached to a printed circuit board, according to an embodiment of the present invention; and

FIG. 4b shows a sensor comprising two light absorbing materials, one for ambient light and one for infrared light, and two transparent materials stacked on top of each other on a substrate attached to a printed circuit board, according to an embodiment of the present invention; and

FIG. 4c shows a sensor comprising two light absorbing materials, one for ambient light and one for infrared light, and a reflective material stacked on top of each other on a substrate attached to a printed circuit board, according to an embodiment of the present invention; and

FIG. 5 shows a sensor comprising three light absorbing materials stacked on top of each other on a substrate attached to a printed circuit board, according to an embodiment of the present invention; and

FIG. 6 shows a portable communication device incorporating a sensor according to an embodiment of the present invention.

### DETAILED DESCRIPTION

Embodiments of the present invention relate, in general, to the field of mobile communication devices and, in particularly, to the creation of area conservative multifunctional sensors for detection of photons in several wavelength ranges. A preferred embodiment relates to a portable communication device, such as a mobile phone, including one or more such area conservative sensors. However, it should be appreciated that the invention is as such equally applicable to electronic devices which do not include any radio communication capabilities. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

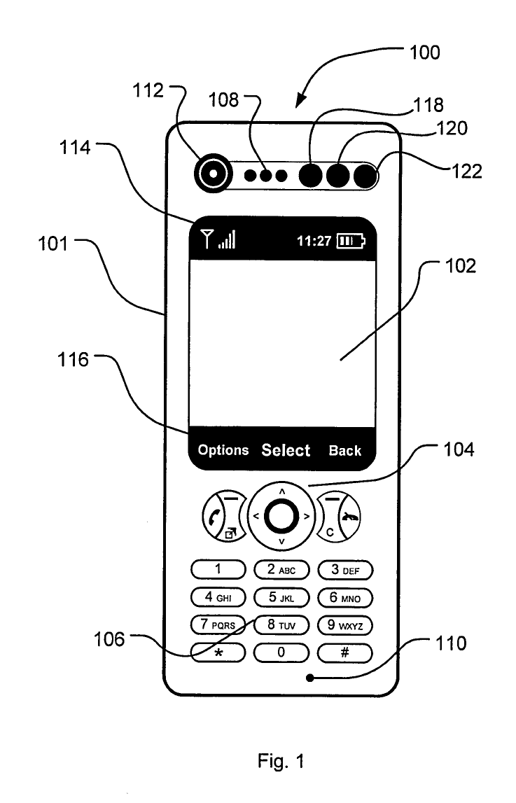

FIG. 1 shows a portable communication device 100 comprising a casing 101, a display area 102, and means 104 for navigating among items (not shown) displayed in the display area. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The portable communication device 100 can also comprise other elements normally present in such a device, such as a keypad 106, a speaker 108, a microphone 110, a camera 112, a photo sensor 118 (e.g. ambient light sensor), a infrared light (IR) sensor 120, infrared light emitting diode 122 (IR LED), processing means (not shown), memory means (not shown), one or more accelerometers (not shown), a vibration device (not shown), an AM/FM radio transmitter and receiver (not shown), a digital audio broadcast transmitter and receiver (not shown), a Bluetooth device (not shown), an antenna module (not shown), etc.

As shown in FIG. 1, the top part of the mobile phone may house several electronic components such as a camera 112, a speaker 108, a photo sensor 118, an IR sensor 120, an IR LED 122, an antenna module (not shown), and both analog and digital circuitry processing signals from these electronic devices. To fit all these electronic devices in the top part of the mobile phone can be a quite demanding task both for the hardware designer and for the designer of the casing. Therefore, it would be most welcome if the number of electronic components could be combined in a way so that they would not occupy so much area in the mobile phone.

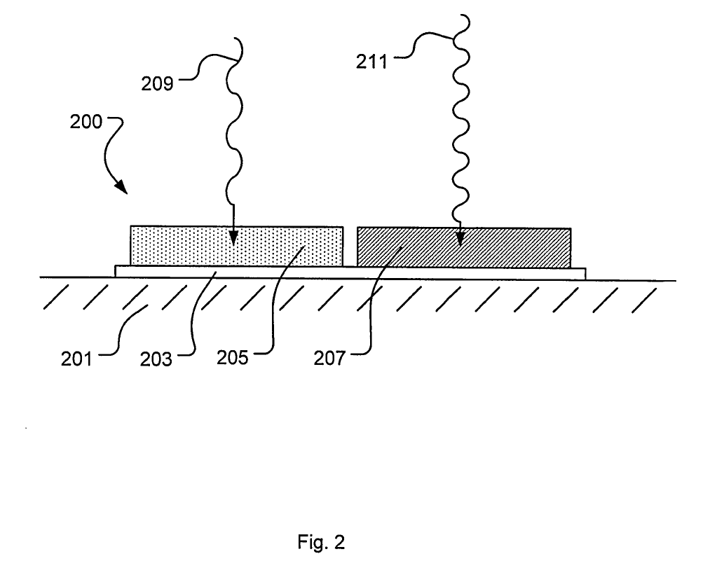

FIG. 2 shows two sensors 200 comprised of two light absorbing materials 205, 207, configured to absorb photons in different wavelength ranges 209, 211, placed side-by-side on a non-conducting substrate 203 which is fastened, by a gluing, soldering, or any other fastening method, onto a printed circuit board 201. In a mobile phone, one of the sensors may for instance be a sensor configured to detect infrared light (IR light) emitted by a for instance an IR LED, thus being comprised of a light absorbing material 205 which absorbs photons 209 roughly within a wavelength range of 700 nm (IR A band)-1 mm (IR C band), according to the definition set by the International Commission on Illumination (CIE). The other sensor may for instance be a sensor configured to detect visible light (or ambient light), thus being comprised of a light absorbing material 207 which absorbs photons 211 roughly within a wavelength range of 380 nm (violet light)-700 nm (red light), according to the definition set by the International Commission on Illumination (CIE). It is easy to see that the sensors shown in FIG. 1 will consume lot of area both on the printed circuit board (201) and on the casing. Therefore, a more area conservative solution would be most welcome.

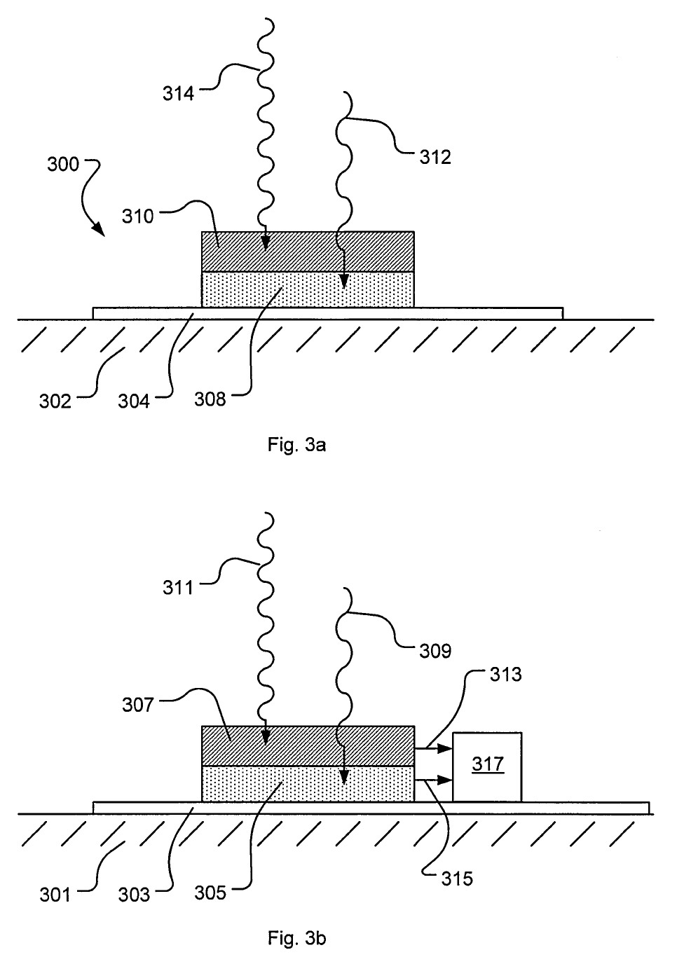

FIG. 3a shows an embodiment of the present invention. The sensor 300 in FIG. 3a comprise of two layers of light absorbing materials 308, 310, arranged on top of each other. The first layer of light absorbing material 310 is configured to absorb photons of a first wavelength range 314 and being transparent to photons of a second wavelength range 312, while the second layer of the light absorbing material 308 is configured to absorb photons of a second wavelength range 312. The second layer 308 may either be configured to absorb photons of the first wavelength range or configured to be transparent to the photons of the first wavelength range. The first and the second light absorbing materials 308, 310, are arranged, or fastened, on a substrate 304, which may house other electronic components performing functions in the mobile phone, and the substrate 304 are also arranged, or fastened, on a PCB 302 which also may house other electronic circuits and devices performing functions in the mobile phone. Photons having a wavelength corresponding to the first wavelength range 314 impinging on the sensor will be absorbed by the first layer of light absorbing material 310, while photons having a wavelength corresponding to the second wavelength range 312 impinging on the sensor will pass through the first layer of light absorbing material 310 and be absorbed by the second layer of light absorbing material 308. In this way the combined sensor comprising the two stacked layers of light absorbing material may be able to detect photons in their respective wavelength ranges as in the case shown in FIG. 1, while only consuming half the area on the substrate and on the PCB.

In an embodiment, the first (top) layer of the light absorbing material 310 may for instance be configured to absorb photons in the visible light spectrum of 200-1000 nm by for instance manufacturing the layer of light absorbing material out of silicon (Si). The second (bottom) layer of the light absorbing material 308 may for instance be configured to absorb photons in the IR spectrum of 1000-1800 nm by for instance manufacturing the layer of light absorbing material out of Indium-Gallium-Arsenide (InGaAs). In this way a combined and area conservative sensor 300 tuned to detect both visible light 314 and IR light 312, independently, has been created. An advantage of this embodiment is that both materials, Si and InGaAs, are widely used in other photoelectrical components such as photodiodes, and are therefore both quite cheap to manufacture and compatible to a whole range of optical components and devices on the market.

In another embodiment the first (top) layer of the light absorbing material 310 may for instance be configured to absorb photons in the visible light spectrum of 400-800 nm by for instance manufacturing the layer of light absorbing material out of Gallium-Arsenide-Phosphor (GaAsP). The second (bottom) layer of the light absorbing material 308 may for instance be configured to absorb photons in the IR spectrum of 600-1000 nm by for instance manufacturing the layer of light absorbing material out Gallium-Arsenide (GaAs). In this embodiment there is an overlap in the absorption range between the two layers. Ideally, photons in the overlapping wavelength range 600-800 nm will be absorbed by the first (top) layer 310, however in practice some photons may not be absorbed in the first (top) layer 310 and instead be absorbed in the second (bottom) layer 308. An advantage of this embodiment is that many of the IR LEDs used in the mobile phone industry, and in consumer electronics, uses IR LEDs that emits IR light in the wavelength range of 850 nm-950 nm. Thus, the combined sensor presented in this embodiment is perfect tuned to be used together with such IR LEDs. A typical implementation would be to use an IR LED together with the combined sensor to implement the combined functions of proximity detection of the user using the device and detection of ambient light level in the mobile phones surrounding.

FIG. 3b shows a similar construction as presented in conjunction with FIG. 3a comprising two layers of light absorbing materials 305, 307, arranged on top of each other, where the first layer of the light absorbing material 307 may be configured to absorb photons of a first wavelength range 311 and being transparent to photons of a second wavelength range 309, while the second layer of the light absorbing material 305 may be configured to absorb photons of a second wavelength range 309. The first and the second light absorbing materials 305, 307 are arranged or fastened on a substrate 303 which in this figure also house an processing unit 317 connected to both the first 307 and the second layer 305 by some communication means such as wires 313, 315. The processing unit may be configured to receive signals from the two layers 305, 307, depending on the number of impinging photons. The processing unit 317 may be adapted to evaluate one or more output signals from the light absorbing materials, either separately or combined. The substrate 303 may be arranged or fastened on a PCB 301 which also may house other electronic circuits and devices which may be connected to the processing unit 317, performing functions in the mobile phone. In this way the combined sensor may be used in several different ways. For example, only one of the sensors may be active at a given time, thus saving power, or both may be active at the same time working independently with other functions and components in the mobile phone (e.g. performing proximity sensing and ambient light sensing in parallel), or both sensors may be active at the same time and working with the same application (e.g. detecting photons in a wider wavelength range) and components in the mobile phone.

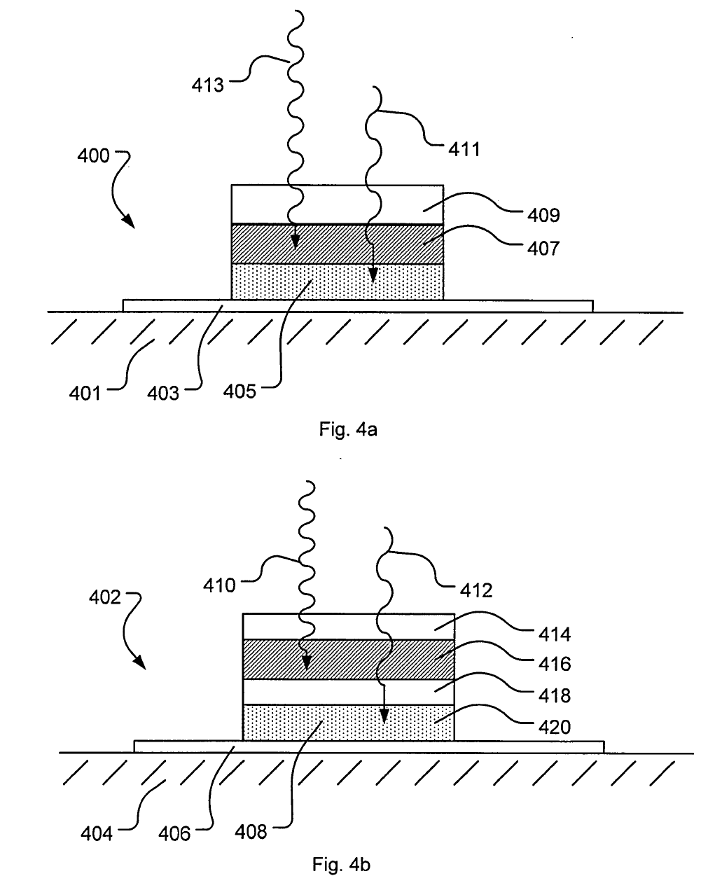

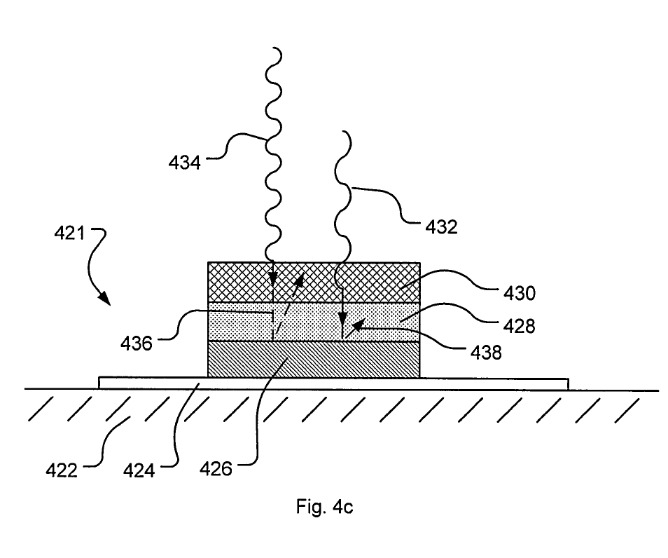

FIG. 4a shows another embodiment of the present invention. In this embodiment a third layer 409 has been added to the top of the sensor stack 400 already comprising two layers of light absorbing materials 405, 407, a substrate 403, and a PCB 401. The third layer may for instance be made of a material such as glass, plastic, gas, crystal, or liquid material (or a combination of those materials) which may be completely (or mostly) transparent to photons having a wavelength corresponding to the first and second wavelength ranges of the two other layers 405, 407. In an embodiment a third layer of glass or plastic may for instance be added to protect the top layer 407 or the whole of the sensor 400 by encasing it (not shown in the figure). In another embodiment a third layer, acting as a lens made of any of the materials mentioned above, may be added to focus, or collecting light (photons), belonging to one or both of the wavelength ranges absorbed by the two layers 405, 407, thus being able to increase the output signal from one or both layers 405, 407. In another embodiment the third layer may also act as a filter blocking photons of a specific wavelength, since in some applications a specific wavelength range may need to be filtered out (e.g. blocking the photons belonging to that wavelength range) so that the photons of that wavelength is not detected (absorbed) by the sensor (any of the light absorbing layers), thus limiting the detection range of the sensor or blocking interfering photons (compare with noise).

FIG. 4b shows another embodiment of the present invention. In this embodiment a third layer 414 and a fourth layer 418 has been added to the sensor 402. The third and the fourth layer may for instance be made of a material which may be completely transparent, semi-transparent, or non-transparent (blocking) to photons belonging to any of the wavelength ranges absorbed by the two layers 405, 407. In this way a sensor detecting one or several specific or narrow wavelength ranges may be constructed. In an embodiment, the first layer may be made of glass to protect the second layer which for instance absorbs photons in a specific wavelength range, and the third layer may be made in such way that it acts as a filter filtering out any photons belonging to the wavelength range not absorbed by the second layer. In this way unwanted photons belonging to a specific wavelength range is effectively filtered out. This may especially be valuable when the two absorbing layers 416, 420 have overlapping absorption wavelength ranges, and when photons not absorbed by the first layer 416 shouldn't be absorbed (detected) by the second layer 420. In another embodiment (not shown in the figure) the first layer 414 may be a protective glass (protecting the second layer or the whole sensor), the second layer 416 may absorb photons in a first wavelength range, the third layer 418 may absorb photons in a second wavelength range, and the fourth layer 420 may absorb photons in a third wavelength range, thus effectively creating a sensor capable of detecting photons belonging to three wavelength ranges.

FIG. 4c shows another embodiment of the present invention. In this embodiment a third reflective layer 426 has been added as a bottom layer to the sensor stack 412. The third layer may be made so as to reflect photons belonging to the first and/or the second wavelength ranges absorbed by the first 430 and the second 428 light absorbing materials. All impinging photons 434, 432, may for instance not be absorbed by the two layers of light absorbing materials 428, 430, but instead pass right through them 436, 438. The non-absorbed photons 436, 438 may then be reflected back into corresponding light absorbing materials and be absorbed, thus increasing the efficiency of the sensor.

Several layers with absorbing, transparent and reflective characteristics may be combined (stacked in any combination) in any given way to create any type of sensor capable of detecting photons in one or a multitude of wavelength ranges.

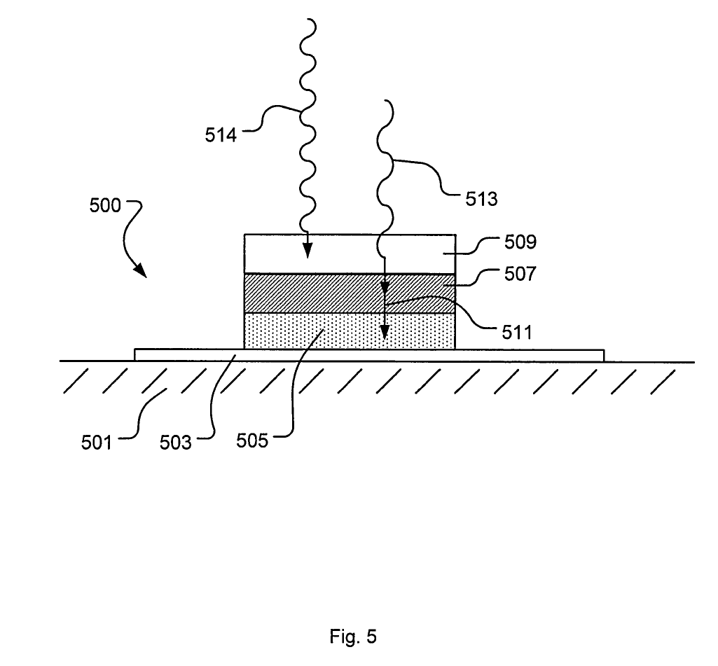

FIG. 5 shows yet another embodiment of the present invention. In this embodiment a first layer 509 may be configured to absorb photons in a first wavelength range 514, a second layer 507 may be configured to absorb photons in a second wavelength range 513, a third layer 505 may be configured to absorb photons in part or in the whole range of the second wavelength range 513. In this way the third layer 505 may be used to absorb any non-absorbed photons 511 by the second layer 507, or it may be used to absorb non-absorbed photons only in as specific part of the second wavelength range. For example, the second layer 507 was supposed to absorb photons in the whole range of a second wavelength range (compare with the sensor in FIG. 3a). However, instead of using a single second layer 507, two layers 507, 505, made of different materials, may be used to cover the whole second wavelength range, or if the second layer 507 is constructed of a material that only absorbs for example 50% of all impinging photons in the second wavelength range, another layer 505 made of another material may be used to absorb the other 50% 511, thus together absorb nearly 100% of the photons in the second wavelength range.

The third layer 505 may also, as discussed in conjunction with previous embodiments above, be made of a material that absorbs photons in a third wavelength range, or in an overlapping wavelength range to the first and the second wavelength ranges, or an extended wavelength range extending from a part of the second wavelength range into a third wavelength range. Depending on which of the combinations one chooses to use several different embodiments are possible resulting in sensors with different characteristics.

The amount of absorption may in all the above described embodiments be controlled by tuning the thickness of each layer of light absorbing material. A thicker layer will have a higher absorption rate and vise versa.

The different layers of light absorbing materials described in conjunction with the embodiments above may be made of any, suitable for the task, semiconducting material or other material (or combination of materials) which absorbs photons in a specific wavelength range or of a specific wavelength.

The wording ‘wavelength range’ should in the above embodiments of the present invention be interpreted both as a wavelength range (i.e. a multitude of wavelengths) and as a single wavelength.

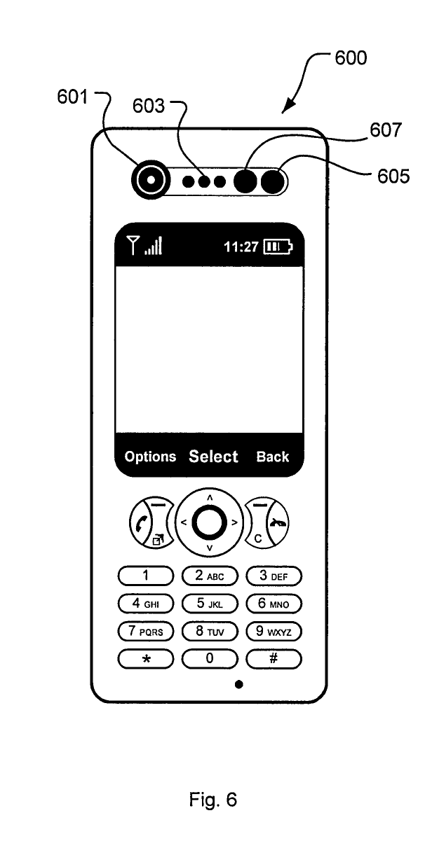

FIG. 6 shows a mobile phone fitted with a combined sensor according to the present invention described in above embodiments. By utilizing a combined sensor it is possible, as seen in the figure, to save both casing area and area on the PCB (not shown).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. Sensor adapted for a portable communication device, comprising;
a first layer of a light absorbing material configured to absorb photons of a first wavelength range and being transparent to photons of a second wavelength range;
a second layer of a light absorbing material configured to absorb photons of a second wavelength range;
wherein the first and the second light absorbing material are arranged on a substrate housing electronic components of the portable communication device, whereby the first and the second light absorbing material are arranged on top of each other, and
wherein at least one of the light absorbing materials are adapted to detect the level of ambient light.

2. The sensor according to claim 1, wherein the sensor further comprises a third layer of a light absorbing material configured to absorb photons of a third wavelength range and being transparent to photons of said first and second wavelength ranges.

3. The sensor according to claim 1, wherein the second layer of a light absorbing material is configured to be transparent to photons of said first wavelength range.

4. The sensor according to claim 1, wherein the sensor further comprises a third layer configured to be transparent to photons of said first and second wavelength ranges.

5. The sensor according to claim 1, wherein the sensor further comprises a fourth layer configured to reflect photons of said first or second wavelength ranges.

6. The sensor according to claim 1, wherein at least one of the light absorbing materials are adapted to detect the level of infrared light.

7. The sensor according to claim 1, wherein at least one of the light absorbing materials are made of silicon, tuned to absorb photons in the wavelength range 200 nm to 1000 nm.

8. The sensor according to claim 1, wherein at least one of the light absorbing materials are made of indium, gallium, and arsenide, tuned to absorb photons in the wavelength range 1000 nm to 1800 nm.

9. The sensor according to claim 1, wherein at least one of the light absorbing materials are made of phosphor, gallium, and arsenide tuned to absorb photons in the wavelength range 400 nm to 800 nm.

10. The sensor according to claim 1, wherein at least one of the light absorbing materials are made of gallium and arsenide tuned to absorb photons in the wavelength range 600 nm to 1000 nm.

11. The sensor according to claim 1, wherein the sensor is further connected to a processing unit adapted to evaluate one or more output signals from the light absorbing materials.

12. The sensor according to claim 11, wherein the processing unit is adapted to evaluate the output signals from the light absorbing materials separately for each absorbing material.

13. The sensor according to claim 11, wherein the processing unit is adapted to evaluate a combination of output signals from the light absorbing materials.

14. The sensor according to claim 4, wherein said third layer comprise of any, or a combination, of the following transparent materials; glass, plastic, gas, crystal, or liquid.

15. A portable communication device comprising the sensor according to claim 1.

16. The portable communication device according to claim 15, further comprise means for evaluating one or more output signals from the light absorbing materials.

17. The portable communication device according to claim 16, further comprise means for evaluating the output signals from the light absorbing materials separately for each absorbing material.

18. The portable communication device according to claim 16, further comprise means for evaluating a combination of output signals from the light absorbing materials.
